(19) United States
(12) Patent Application Publication
(10) Pub. No.: US 2016/0370596 A1
(43) Pub. Date: Dec. 22, 2016

(54) THREE-DIMENSIONAL DISPLAY

(71) Applicant: EMPIRE TECHNOLOGY DEVELOPMENT LLC, Wilmington, DE (US)

(72) Inventor: Eiji YAMAICHI, Tokyo (JP)

(21) Appl. No.: 15/122,315

(22) PCT Filed: Feb. 27, 2014
(86) PCT No.: PCT/US2014/019103

§ 371 Date: Aug. 29, 2016

(51) Int. Cl. G02B 27/22; G02B 6/06

(52) U.S. Cl. CPC G02B 27/2278; G02B 6/06

(57) ABSTRACT

Technologies are generally described for displaying a three-dimensional image. Example devices/systems described herein may use a plurality of light guides arranged in an array, and light emissive elements provided along a longitudinal direction of the light guides. A light emission intensity of each of the light emissive elements may be controlled based on an input signal indicative of the object, to generate a three-dimensional image of the object. The three-dimensional image may have a perceived depth in the longitudinal direction determined by light emission intensity ratios between the light emissive elements. The light guides may include at least one of optical fibers, glass rods, glass tubes, transparent-walled channels and elongated voids in a matrix material. Also, the light emissive elements may include at least one of light emitting diodes (LEDs), plasma light emitters, luminescent elements, and light emissive pixels of a flat panel display.

### BACKGROUND

Unless otherwise indicated herein, the approaches described in this section are not prior art to the claims in this application and are not admitted to be prior art by inclusion in this section.

A depth fused three-dimensional (DFD) display device can be used to display three-dimensional images of objects, such that an observer can view the objects as if they are positioned at different depths in a three-dimensional space. The DFD display device may typically include two display panels provided at different depths as viewed from an observer. For example, the display panels may be implemented using transparent liquid crystal display (LCD) panels. Also, a backlight source may be arranged at a backside of a display panel located farther than the other display panel from the observer. In such configuration, a two-dimensional image of an object can be displayed on each display panel by projecting the image on the display panels from a viewing direction of the observer. In addition, the light transmittance of the two display panels may be respectively adjusted such that the observer can view a three-dimensional image of the object formed due to the difference in the light transmittance of the two-dimensional images displayed on the corresponding display panels.

In some conventional DFD display devices, light emitted from the backlight source can pass through multiple display panels before reaching the observer. Accordingly, when the light transmittance of one of the display panels (e.g., one located closer to the backlight source) is adjusted to be significantly lower than the other, the intensity of light passing through the display panels may be too weak to be detected by the observer. This problem may deteriorate the quality of the three-dimensional image as viewed by the observer.

### SUMMARY

Technologies are generally described for displaying a three-dimensional image of an object in a depth-fused three-dimensional (DFD) display device.

Various example devices configured to display a three-dimensional image of an object described herein may include one or more of a plurality of light guides, and/or one or more light emissive elements. The plurality of light guides may be oriented substantially in a longitudinal direction and arranged in a two-dimensional array in a transverse plane. The one or more light emissive elements may be provided along the longitudinal direction of each of the light guides. Also, each of the light emissive elements may be configured to emit light based on an input signal indicative of the object. The plurality of light guides and the one or more light emissive elements may be effective to form the three-dimensional image of the object due to a difference between light emission intensities of the one or more light emissive elements.

In some examples, methods for displaying a three-dimensional image of an object in a display device are described. The display device may include one or more of a plurality of light guides oriented substantially in a longitudinal direction and arranged in a two-dimensional array in a transverse plane, and/or one or more light emissive elements provided along the longitudinal direction of each of the light guides. Example methods may include receiving, by the one or more light emissive elements, an input signal indicative of the object. Light may be emitted, by each of the one or more light emissive elements, based on the input signal. The three-dimensional image of the object may be formed due to a difference between light emission intensities of the one or more light emissive elements.

In some examples, a computer-readable storage medium is described that may be adapted to store a program operable by a display device to generate a three-dimensional image of an object. The processor may include various features as further described herein. The program may include one or more instructions for receiving, by the one or more light emissive elements, an input signal indicative of the object, and emitting, by each of the one or more light emissive elements, light based on the input signal. The program may further include one or more instructions for forming the three-dimensional image of the object due to a difference between light emission intensities of the one or more light emissive elements.

In some examples, display devices configured to display a three-dimensional image of an object are described. Example devices may include one or more of light guides, light emissive elements, and/or a controller. The light guides may be arranged in an array, where each light guide may be elongated along a longitudinal direction. The controller may be operable to control a light emission intensity of each of the light emissive elements based on an input signal indicative of the object. The three-dimensional image may have a perceived depth in the longitudinal direction determined by light emission intensity ratios between the light emissive elements.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows a perspective view of an illustrative example display device including a plurality of light guides configured to display a three-dimensional image of an object;

FIGS. 2A and 2B schematically show a light guide that may be used in a display device, including LEDs (light emitting diodes) provided proximate front and back ends of the light guide along a longitudinal direction of the light guide;

FIGS. 3A and 3B schematically show a light guide that may be used in a display device, including a plurality of LEDs provided at substantially regular intervals along a longitudinal direction of the light guide;

FIGS. 4A and 4B schematically show a light guide that may be used in a display device, including plasma light emissive elements provided proximate front and back ends of the light guide along a longitudinal direction of the light guide;

FIGS. 5A and 5B schematically show light guides that may be used in a display device, including plasma light emissive elements provided proximate front and back ends of the light guides along a longitudinal direction of the light guides, where the plasma light emissive elements are coated with red, green and blue fluorescent materials;

FIG. 6 schematically shows a perspective view of an illustrative example display device configured to display a three-dimensional image of an object, where a flat display panel is arranged in a transverse plane of back ends of a plurality of light guides;

FIGS. 7A and 7B schematically show light guides that may be used in a display device, including plasma light emissive elements provided proximate front ends of the light guides and light emissive pixels of a flat display panel proximate back ends of the light guides, along a longitudinal direction of the light guides, where the plasma light emissive elements are coated with red, green and blue fluorescent materials;

FIG. 8 illustrates an example flow diagram of a method adapted to display a three-dimensional image of an object;

FIG. 9 shows a schematic block diagram illustrating an example computing system that can be configured to implement methods for displaying a three-dimensional image of an object; and

FIG. 10 illustrates computer program products that can be utilized to display a three-dimensional image of an object, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices and computer program products related to displaying a three-dimensional image of an object in a depth-fused three-dimensional (DFD) display device.

Briefly stated, technologies are generally described for displaying a three-dimensional image of an object. Example devices/systems described herein may use one or more of light guides arranged in an array, light emissive elements provided along a longitudinal direction of the light guides, and/or a controller. In various examples, a display device is described, where the device may be configured to display a three-dimensional image of an object. Each of the light guides may be elongated along a longitudinal direction. The controller may be operable to control a light emission intensity of each of the light emissive elements based on an input signal indicative of the object. According to the above configuration, the displayed three-dimensional image may have a perceived depth in the longitudinal direction determined by light emission intensity ratios between the light emissive elements. In some embodiments, the light guides may include at least one of optical fibers, glass rods, glass tubes, transparent-walled channels, and elongated voids in a matrix material. In some embodiments, the light emissive elements may include at least one of light emitting diodes (LEDs), plasma light emitters, luminescent elements, and light emissive pixels of a flat panel display.

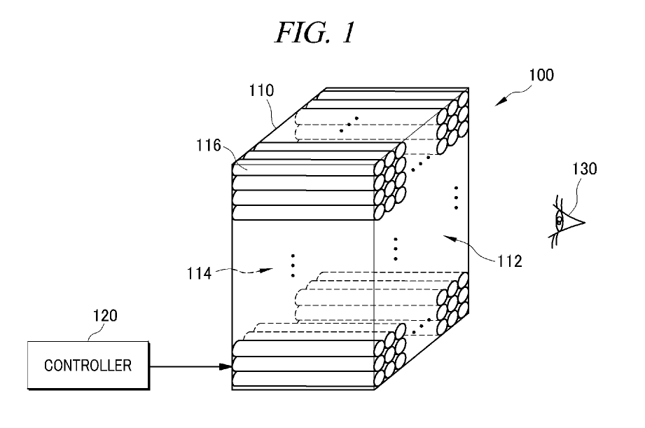

FIG. 1 schematically shows a perspective view of an illustrative example display device including a plurality of light guides configured to display a three-dimensional image of an object, arranged in accordance with at least some embodiments described herein. As depicted, a display device 100 may include one or more of a three-dimensional (3D) display unit 110, and/or a controller 120. 3D display unit 110 may include a plurality of light guides 116, which may be oriented substantially in a longitudinal direction and arranged in a two-dimensional array in a transverse plane of 3D display unit 110. One or more light emissive elements (not shown) may be provided along the longitudinal direction of each of light guides 116, which will be described in more detail below.

In operation, controller 120 may be operable to control a light emission intensity of each of the light emissive elements based on an input signal indicative of the object. In some embodiments, the input signal may include three-dimensional coordinate information of the object, and the light emissive elements may emit light based on the three-dimensional coordinate information of the object. Thus, the plurality of light guides 116 with the light emissive elements arranged along the longitudinal direction thereof may be effective to form the three-dimensional image of the object due to a difference between light emission intensities of the light emissive elements. As a result, the three-dimensional image may have a perceived longitudinal position along each of light guides 116 which may be determined by at least one light emission intensity ratio between more than one light emissive elements of the plurality of light emissive elements.

In some embodiments, a first light emissive element and a second light emissive element among the one or more light emissive elements may be arranged at different depths from a viewing direction of an observer 130. For example, the first light emissive element may be arranged proximate a back side of 3D display unit 110, while the second light emissive element may be arranged proximate a front side of 3D display unit 110 which is closer than the first light emissive element to observer 130.

In some embodiments, the first light emissive element and the second light emissive element may be separated by a longitudinal distance of at least half the length of each light guide 116.

In some embodiments, the first light emissive element may be configured to emit light with first light emission intensity which may be controlled by controller 120 based on the input signal. Also, the second light emissive element may be configured to emit light with second light emission intensity which may also be controlled by controller 120 based on the input signal. As the three-dimensional coordinate information indicated in the input signal may vary, the light emission intensities of the first and second light emissive elements can also vary accordingly. As a result, a depth of the object perceived by observer 130 may be determined according to a light emission intensity ratio between the first and second light emissive elements.

In some embodiments, the plurality of light guides 116 may be formed of at least one of a plurality of optical fibers, a plurality of hollow glass tubes, a plurality of glass rods, a plurality of transparent-walled channels, and a plurality of elongated voids in a matrix material, e.g., made of glass or transparent resin.

In some embodiments, the light emissive elements may include at least one of LEDs (e.g., red LEDs, green LEDs and blue LEDs), luminescent elements, and plasma light emissive element (or plasma light emitter) configured to generate light by exciting plasma of one or more noble gases. A light guide may partially (such as mostly or substantially completely) confine and guide the light from the light emissive elements within the light guide, so that there is a certain level of light transmission through the light guide. Each light guide may be associated with a single color emission, and in some examples each light guide may be associated with a plurality of color emissions. The luminescent elements may include at least one of fluorescent elements, photoluminescent elements, electroluminescent elements, cathodoluminescent elements, and phosphor elements. The noble gases may include at least one of helium (He), neon (Ne), argon (Ar), krypton (Kr), xenon (Xe), and radon (Rn). Additionally or alternatively, an inside of each of the plasma light emissive elements may be coated with at least one of a red fluorescent material, a green fluorescent material, and a blue fluorescent material. For example, the fluorescent materials may include at least one of Y₂O₃:Eu, YP_{0.65}V_{0.35}O₄:Eu, YBO₃:Eu, Y_{0.65} Gd_{0.35}BO₃:Eu, Zn₂SiO₄:Mn, BaAl₁₂O₁₉:Mn, CaWO₄:Pb, Y₂SiO₅:Ce, YP_{0.85}V_{0.15}O₄, BaMg₂Al₁₄O₂₄:Eu, and BaMgAl₁₄O₂₃:Eu.

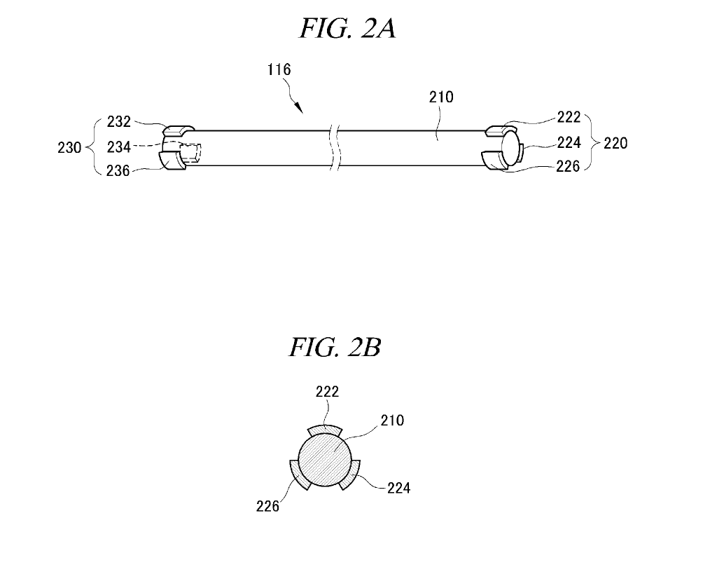

FIGS. 2A and 2B schematically show a light guide that may be used in a display device, including LEDs provided proximate front and back ends of the light guide along a longitudinal direction of the light guide, arranged in accordance with at least some embodiments described herein.

As depicted in FIG. 2A, a light guide 116 may include a light guide member 210, a first light emissive element 220 and a second light emissive element 230 provided along a longitudinal direction of light guide member 210. First light emissive element 220 may be proximate a first end (e.g., front end) of light guide 116, while second light emissive element 230 may be proximate a second end (e.g., back end) of light guide 116. First light emissive element 220 may include three LEDs 222, 224, and 226 (e.g., a red LED 222, a green LED 224, a blue LED 226), which may be arranged at substantially regular intervals around a circumference of light guide member 210 as shown in FIG. 2B. Similarly, second light emissive element 230 may include three LEDs 232, 234, and 236 (e.g., a red LED 232, a green LED 234, a blue LED 236), which may be arranged at substantially regular intervals around a circumference of light guide member 210.

In some embodiments, light guide member 210 may be formed of at least one of an optical fiber, a hollow glass tube, a glass rod, a transparent-walled channel, and an elongated void in a matrix material, e.g., made of glass or transparent resin. In some embodiments, a plurality of light guides including light guide 116 may be employed in a display device such as display device 100, where the plurality of light guides may be oriented substantially in a longitudinal direction and arranged in a two-dimensional array in a transverse plane, as shown in FIG. 1.

In operation, each of first and second light emissive elements 220 and 230 may be configured to emit light with light emission intensity adjusted based on an input signal indicative of an object, which may be controlled by a controller such as controller 120 in a similar manner as described above with respect to FIG. 1. In some embodiments, the input signal may include three-dimensional coordinate and/or color information of the object, and first and second light emissive elements 220 and 230 may emit light based on the three-dimensional coordinate and/or color information of the object. For example, LEDs 222 to 226 of first light emissive element 220 may be configured to emit RGB (red, green blue) color light (or other color scheme) based on the three-dimensional coordinate and/or color information. Similarly, LEDs 232 to 236 of second light emissive element 230 may be configured to emit RGB color light based on the three-dimensional coordinate and/or color information. Thus, light guide member 210 and first and second light emissive elements 220 and 230 may be collectively effective to form a portion of a color three-dimensional image of the object due to a difference between light emission intensities of first and second light emissive elements 220 and 230. As a result, the portion of the color three-dimensional image may have a perceived longitudinal position along light guide 116 which may be determined by a light emission intensity ratio between first and second light emissive elements 220 and 230.

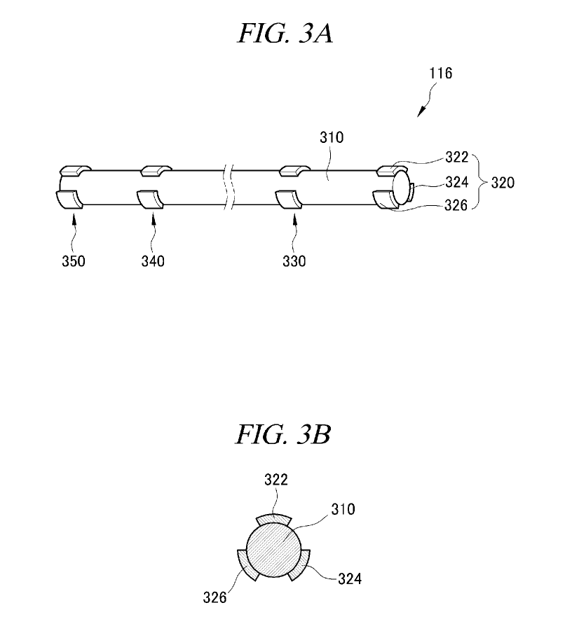

FIGS. 3A and 3B schematically show a light guide that may be used in a display device, including a plurality of LEDs provided at substantially regular intervals along a longitudinal direction of the light guide, in accordance with at least some embodiments described herein.

As depicted in FIG. 3A, a light guide 116 may include a light guide member 310, a plurality of light emissive elements 320, 330, 340 and 350 provided along a longitudinal direction of light guide member 310. Plurality of light emissive elements 320 to 350 may be arranged to be space substantially equally apart from each other along the longitudinal direction of light guide member 310. Light emissive element 320 may be provided proximate a first end (e.g., front end) of light guide 116, while light emissive element 350 may be provided proximate a second end (e.g., back end) of light guide 116. Each of light emissive elements 320 to 350 may include three LEDs 322, 324, and 326 (e.g., a red LED 322, a green LED 324, a blue LED 326), which may be arranged at substantially regular intervals around a circumference of light guide member 310 as shown in FIG. 3B.

In some embodiments, light guide member 310 may be formed of at least one of an optical fiber, a hollow glass tube, a glass rod, a transparent-walled channel, and an elongated void in a matrix material, e.g., made of glass or transparent resin. In some embodiments, a plurality of light guides including light guide 116 may be employed in a display device such as display device 100, where the plurality of light guides may be oriented substantially in a longitudinal direction and arranged in a two-dimensional array in a transverse plane, as shown in FIG. 1.

In operation, each of light emissive elements 320 to 350 may be configured to emit light with light emission intensity adjusted based on an input signal indicative of an object, which may be controlled by a controller such as controller 120 in a similar manner as described above with respect to FIG. 1. In some embodiments, the input signal may include three-dimensional coordinate and/or color information of the object, and light emissive elements 320 to 350 may emit light based on the three-dimensional coordinate and/or color information of the object. For example, LEDs 322 to 326 of each light emissive element may be configured to emit RGB color light based on the three-dimensional coordinate and/or color information. Thus, light guide member 310 and light emissive elements 320 to 350 may be collectively effective to form a portion of a color three-dimensional image of the object due to a difference between light emission intensities of light emissive elements 320 to 350. As a result, the portion of the color three-dimensional image may have a perceived longitudinal position along light guide 116 which may be determined by a light emission intensity ratio between light emissive elements 320 to 350.

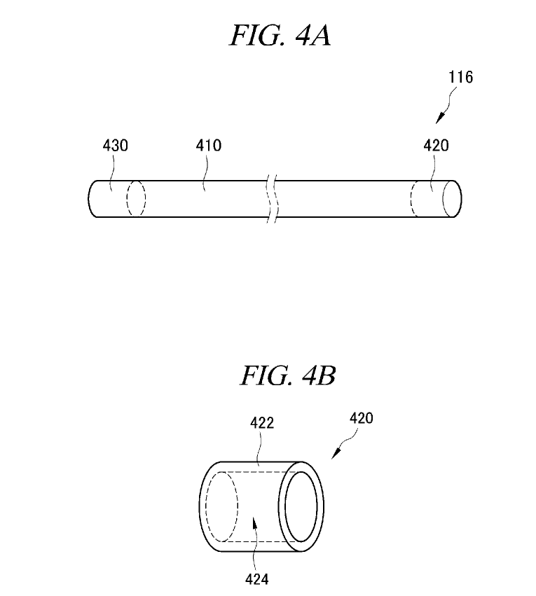

FIGS. 4A and 4B schematically show a light guide that may be used in a display device, including plasma light emissive elements provided proximate front and back ends of the light guide along a longitudinal direction of the light guide, arranged in accordance with at least some embodiments described herein.

As depicted in FIG. 4A, a light guide 116 may include a light guide member 410, a first light emissive element 420 and a second light emissive element 430 provided along a longitudinal direction of light guide member 410. First light emissive element 420 may be provided proximate a first end (e.g., front end) of light guide 116, while second light emissive element 430 may be provided proximate a second end (e.g., back end) of light guide 116. Each of first and second light emissive elements 420 and 430 may include a plasma light emissive element (or plasma light emitter) configured to generate light by exciting plasma of one or more noble gases. In some embodiments, the noble gases may include at least one of helium (He), neon (Ne), argon (Ar), krypton (Kr), xenon (Xe), radon (Rn), and a mixture thereof. As illustrated in FIG. 4B, each light emissive element 420 may include an electrode 422, which may be provided along a circumference of the light emissive element, and a discharge region 424, which may be filled with the noble gases.

In some embodiments, light guide member 410 may be formed of at least one of an optical fiber, a hollow glass tube, a glass rod, a transparent-walled channel, and an elongated void in a matrix material, e.g., made of glass or transparent resin. In some embodiments, a plurality of light guides including light guide 116 may be employed in a display device such as display device 100, where the plurality of light guides may be oriented substantially in a longitudinal direction and arranged in a two-dimensional array in a transverse plane, as shown in FIG. 1.

In operation, each of first and second light emissive elements 420 and 430 may be configured to emit light with light emission intensity adjusted based on an input signal indicative of an object, which may be controlled by a controller such as controller 120 in a similar manner as described above with respect to FIG. 1. In some embodiments, the input signal may include three-dimensional coordinate and/or color information of the object, and light emissive elements 420 and 430 may emit light with light emission intensity adjusted based on the three-dimensional coordinate and/or color information of the object.

In some embodiments, when a voltage generated based on the input signal is applied to electrode 422 of each light emissive element, plasma of the noble gases filled in discharge region 424 may be excited to generate light with a specific wavelength range. For example, in case of using Ne gas to be filled in discharge region 424, each light emissive element may be configured to emit red light based on the three-dimensional coordinate and/or color information. Thus, light guide member 410 and light emissive elements 420 and 430 may be collectively effective to form a portion of a color three-dimensional image of the object due to a difference between light emission intensities of light emissive elements 420 and 430. As a result, the portion of the color three-dimensional image may have a perceived longitudinal position along light guide 116 which may be determined by a light emission intensity ratio between light emissive elements 420 and 430.

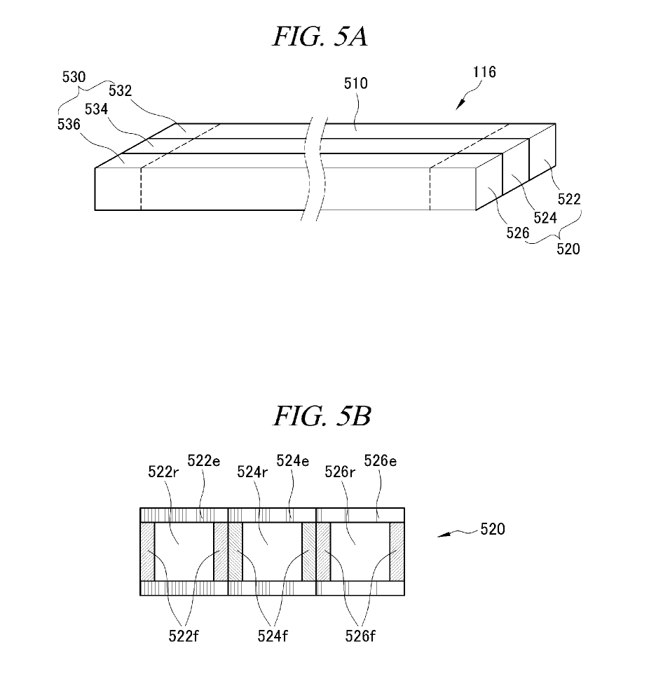

FIGS. 5A and 5B schematically show light guides that may be used in a display device, including plasma light emissive elements provided proximate front and back ends of the light guides along a longitudinal direction of the light guides, where the plasma light emissive elements are coated with red, green and blue fluorescent materials, arranged in accordance with at least some embodiments described herein.

As depicted in FIG. 5A, a light guide 116 may include a light guide member 510, a first light emissive element 520 and a second light emissive element 530 provided along a longitudinal direction of light guide member 510. First light emissive element 520 may be provided proximate a first end (e.g., front end) of light guide 116, while second light emissive element 530 may be provided proximate a second end (e.g., back end) of light guide 116. First light emissive elements 520 may include three plasma light emissive elements 522, 524 and 526 while second light emissive elements 530 may include another three plasma light emissive elements 532, 534 and 536. Each plasma light emissive element (or plasma light emitters) may be configured to generate red, green or blue light by exciting plasma of one or more noble gases and irradiating plasma emission to luminescent elements. In some embodiments, the noble gases may include at least one of He, Ne, Ar, Kr, Xe, and Rn. Further, the luminescent elements may include at least one of fluorescent elements, photoluminescent elements, electroluminescent elements, cathodoluminescent elements, and phosphor elements.

In some embodiments, as illustrated in FIG. 5B, plasma light emissive element 522 of each light emissive element 520 may include an electrode 522e, which may be provided along one or more surfaces of the plasma light emissive element, and a discharge region 522r, which may be filled with the noble gases. Further, plasma light emissive element 522 may include one or more luminescent elements 522f configured to generate red light upon receiving plasma emission. For example, luminescent elements 522f may include red fluorescent materials such as Y₂O₃:Eu, YP_{0.65}V_{0.35}O₄:Eu, YBO₃:Eu, or Y_{0.65}Gd_{0.35}BO₃:Eu. Similarly, plasma light emissive element 524 of each light emissive element 520 may include an electrode 524e, which may be provided along one or more surfaces of the plasma light emissive element, and a discharge region 524r, which may be filled with the noble gases. Further, plasma light emissive element 524 may include one or more luminescent elements 524f configured to generate green light upon receiving plasma emission. For example, luminescent elements 524f may include green fluorescent materials such as Zn₂SiO₄:Mn, or BaAl₁₂O₁₉:Mn. Further, plasma light emissive element 526 of each light emissive element 520 may include an electrode 526e, which may be provided along one or more surfaces of the plasma light emissive element, and a discharge region 526r, which may be filled with the noble gases. Further, plasma light emissive element 526 may include one or more luminescent elements 526f configured to generate blue light upon receiving plasma emission. For example, luminescent elements 526f may include blue fluorescent materials such as CaWO₄:Pb, Y₂SiO₅:Ce, YP_{0.85}V_{0.15}O₄, BaMg₂Al₁₄O₂₄:Eu, or BaMgAl₁₄O₂₃:Eu.

In some embodiments, light guide member 510 may include three light guide members each formed of at least one of an optical fiber, a hollow glass tube, a glass rod, a transparent-walled channel, and an elongated void in a matrix material, e.g., made of glass or transparent resin. In some embodiments, a plurality of light guides including light guide 116 may be employed in a display device such as display device 100, where the plurality of light guides may be oriented substantially in a longitudinal direction and arranged in a two-dimensional array in a transverse plane, as shown in FIG. 1.

In operation, each of first and second light emissive elements 520 and 530 may be configured to emit RGB color light with light emission intensity based on an input signal indicative of an object, which may be controlled by a controller such as controller 120 in a similar manner as described above with respect to FIG. 1. In some embodiments, the input signal may include three-dimensional coordinate and/or color information of the object, and light emissive elements 520 and 530 may emit light based on the three-dimensional coordinate and/or color information of the object.

In some embodiments, when a voltage generated based on the input signal is applied to electrode 522e of plasma light emissive element 522, plasma of the noble gases filled in discharge region 522r may be excited to generate light with a specific wavelength range. For example, in case of using He—Xe mixed gas to be filled in discharge region 522r, plasma light emissive element 522 may be configured to emit ultraviolet (UV) light with light emission intensity adjusted based on the three-dimensional coordinate and/or color information. When the ultraviolet light is irradiated on luminescent element (e.g. fluorescent material) 522f, the fluorescent material may be effective to emit red light in response to the irradiation of the light. More specifically, an orbital electron in the fluorescent material may be excited, by the irradiation of the light, from a current energy level to a higher energy level. Then, as the orbital electron relaxes to a ground energy level, a light having a wavelength corresponding to such energy level transition may be emitted from the fluorescent material. Similarly, plasma light emissive elements 524 and 526 may be configured to emit green and blue light, respectively, with light emission intensities adjusted based on the three-dimensional coordinate and/or color information.

Thus, light guide member 510 and light emissive elements 520 and 530 may be collectively effective to form a portion of a color three-dimensional image of the object due to a difference between light emission intensities of light emissive elements 520 and 530. As a result, the portion of the color three-dimensional image may have a perceived longitudinal position along light guide 116 which may be determined by a light emission intensity ratio between light emissive elements 520 and 530.

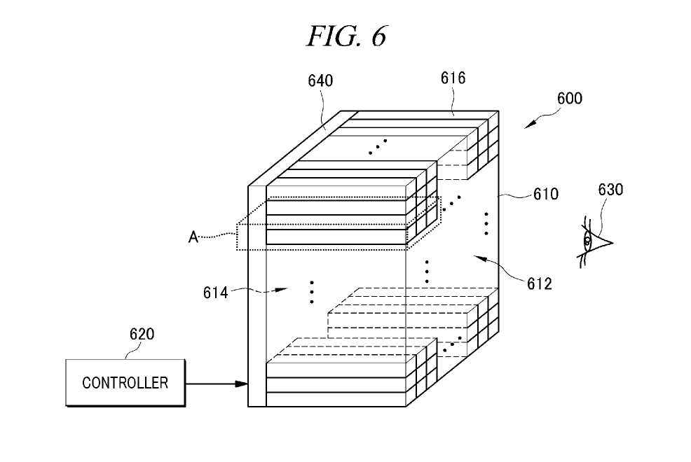

FIG. 6 schematically shows a perspective view of an illustrative example display device configured to display a three-dimensional image of an object, where a flat display panel is arranged in a transverse plane of back ends of a plurality of light guides, arranged in accordance with at least some embodiments described herein.

As depicted in FIG. 6, a display device 600 may include one or more of a 3D display unit 610, a controller 620, and/or a flat display panel 640 such as a LCD (liquid crystal display) panel, which may be arranged in a transverse plane of a back end of 3D display unit 610. 3D display unit 610 may include a plurality of light guides 616, which may be oriented substantially in a longitudinal direction and arranged in a two-dimensional array in a transverse plane of 3D display unit 610. One or more light emissive elements (not shown) may be provided along the longitudinal direction of each of light guides 616, and a portion of the light emissive elements may include light emissive pixels of flat panel display 640, which will be described in more detail below.

In some embodiments, a first light emissive element and a second light emissive element (e.g., a light emissive pixel of flat display panel 640) among the one or more light emissive elements may be arranged at different depths from a viewing direction of an observer 630. For example, the second light emissive element or light emissive pixel may be arranged on flat display panel 640 which may be disposed proximate a back side of 3D display unit 610, while the first light emissive element may be arranged proximate a front side of 3D display unit 610 which is closer than the second light emissive element to observer 130.

In operation, controller 620 may be operable to control a light emission intensity of each of the first and second light emissive elements arranged along each of light guides 616, based on an input signal indicative of the object. In some embodiments, the input signal may include three-dimensional coordinate information and/or color information of the object, and the first and second light emissive elements may emit light with light emission intensities adjusted based on the three-dimensional coordinate information and/or color information of the object. As the three-dimensional coordinate information and/or color information indicated in the input signal may vary, the light emission intensities of the first and second light emissive elements can also vary accordingly. As a result, a depth of the object perceived by observer 630 may be determined according to a light emission intensity ratio between the first light emissive element and the second light emissive element (e.g., a light emissive pixel of flat display panel 640). Thus, plurality of light guides 616, and the first and second light emissive light elements may be collectively effective to form the three-dimensional image of the object due to a difference between light emission intensities of the first and second light emissive elements. As a result, the three-dimensional image may have a perceived longitudinal position along each of light guides 616 which may be determined by at least one light emission intensity ratio between the first and second light emissive elements.

In some embodiments, plurality of light guides 616 may be formed of at least one of a plurality of optical fibers, a plurality of hollow glass tubes, a plurality of glass rods, a plurality of transparent-walled channels, and a plurality of elongated voids in a matrix material, e.g., made of glass or transparent resin.

In some embodiments, the light emissive elements may include at least one of LEDs (e.g., red LEDs, green LEDs and blue LEDs), luminescent elements, and plasma light emissive elements (or plasma light emitters) configured to generate light by exciting plasma of one or more noble gases. The luminescent elements may include at least one of fluorescent elements, photoluminescent elements, electroluminescent elements, cathodoluminescent elements, and phosphor elements. The noble gases may include at least one of He, Ne, Ar, Kr, Xe, and Rn. Additionally or alternatively, an inside of each of the plasma light emissive elements may be coated with at least one of a red fluorescent material, a green fluorescent material, and a blue fluorescent material. For example, the fluorescent materials may include at least one of Y₂O₃:Eu, YP_{0.65}V_{0.35}O₄:Eu, YBO₃:Eu, Y_{0.65}Gd_{0.35}BO₃:Eu, Zn₂SiO₄:Mn, BaAl₁₂O₁₉:Mn, CaWO₄:Pb, Y₂SiO₅:Ce, YP_{0.85}V_{0.15}O₄, BaMg₂Al₁₄O₂₄:Eu, and BaMgAl₁₄O₂₃:Eu.

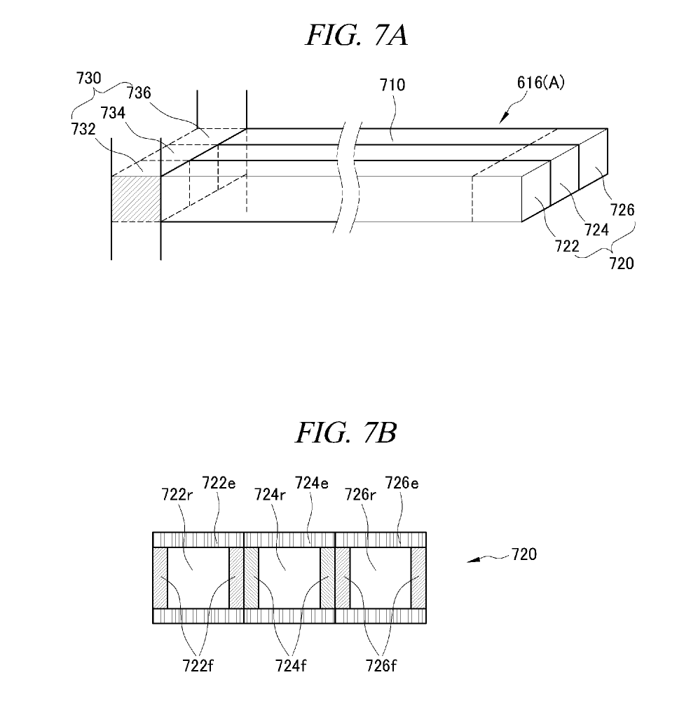

FIGS. 7A and 7B schematically show light guides that may be used in a display device, including plasma light emissive elements provided proximate front ends of the light guides and light emissive pixels of a flat display panel proximate back ends of the light guides, along a longitudinal direction of the light guides, where the plasma light emissive elements are coated with red, green and blue fluorescent materials, arranged in accordance with at least some embodiments described herein.

FIG. 7A illustrates a perspective view of a light guide 616, which is taken from a portion A as shown in FIG. 6. As depicted, light guide 616 may include a light guide member 710 and a light emissive element 720 arranged proximate a first end (e.g., front end) of light guide member 710. Also, a light emissive portion 730 of a flat display panel such as flat display panel 640, including red, green and blue light emissive pixels 732, 734 and 736, may be provided proximate a second end (e.g., back end) of light guide member 710. Further, light emissive element 720 may include three plasma light emissive elements 722, 724 and 726 (or plasma light emitters) configured to generate RGB color light by exciting plasma of one or more noble gases and irradiating plasma emission to luminescent elements. In some embodiments, the noble gases may include at least one of He, Ne, Ar, Kr, Xe, and Rn. Further, the luminescent elements may include at least one of fluorescent elements, photoluminescent elements, electroluminescent elements, cathodoluminescent elements, and phosphor elements.

In some embodiments, as illustrated in FIG. 7B, plasma light emissive element 722 of light emissive element 720 may include an electrode 722e, which may be provided along one or more surfaces of the plasma light emissive element, and a discharge region 722r, which may be filled with the noble gases. Further, plasma light emissive element 722 may include one or more luminescent elements 722f configured to generate red light upon receiving plasma emission. For example, luminescent elements 722f may include red fluorescent materials such as Y₂O₃:Eu, YP_{0.65}V_{0.35}O₄:Eu, YBO₃:Eu, or Y_{0.65}Gd_{0.35}BO₃:Eu. Similarly, plasma light emissive element 724 of light emissive element 720 may include an electrode 724e, which may be provided along one or more surfaces of the plasma light emissive element, and a discharge region 724r, which may be filled with the noble gases. Further, plasma light emissive element 724 may include one or more luminescent elements 724f configured to generate green light upon receiving plasma emission. For example, luminescent elements 724f may include green fluorescent materials such as Zn₂SiO₄:Mn, or BaAl₁₂O₁₉:Mn. Further, plasma light emissive element 726 of light emissive element 720 may include an electrode 726e, which may be provided along one or more surfaces of the plasma light emissive element, and a discharge region 726r, which may be filled with the noble gases. Further, plasma light emissive element 726 may include one or more luminescent elements 726f configured to generate blue light upon receiving plasma emission. For example, luminescent elements 726f may include blue fluorescent materials such as CaWO₄:Pb, Y₂SiO₅:Ce, YP_{0.85}V_{0.15}O₄, BaMg₂Al₁₄O₂₄:Eu, or BaMgAl₁₄O₂₃:Eu.

In some embodiments, light guide member 710 may include three light guide members each formed of at least one of an optical fiber, a hollow glass tube, a glass rod, a transparent-walled channel, and an elongated void in a matrix material, e.g., made of glass or transparent resin. In some embodiments, a plurality of light guides including light guide 616 may be employed in a display device such as display device 600, where the plurality of light guides may be oriented substantially in a longitudinal direction and arranged in a two-dimensional array in a transverse plane, as shown in FIG. 6.

In operation, each of light emissive element 720 and light emissive portion 730 of the flat display panel may be configured to emit RGB color light with light emission intensities adjusted based on an input signal indicative of an object, which may be controlled by a controller such as controller 620 in a similar manner as described above with respect to FIG. 6. In some embodiments, the input signal may include three-dimensional coordinate and/or color information of the object, and light emissive element 720 and light emissive portion 730 may emit light with light emission intensities adjusted based on the three-dimensional coordinate and/or color information of the object.

In some embodiments, when a voltage generated based on the input signal is applied to electrode 722e of plasma light emissive element 722, plasma of the noble gases filled in discharge region 722r may be excited to generate light with a specific wavelength range. For example, in case of using He—Xe mixed gas to be filled in discharge region 722r, plasma light emissive element 722 may be configured to emit ultraviolet light based on the three-dimensional coordinate and/or color information. When the ultraviolet light is irradiated on red fluorescent material 722f, the fluorescent material may be effective to emit red light in response to the irradiation of the light. Similarly, plasma light emissive elements 724 and 726 may be configured to emit green and blue light, respectively, with light emission intensities adjusted based on the three-dimensional coordinate and/or color information.

Thus, light guide member 710, light emissive element 720 and light emissive portion 730 may be collectively effective to form a portion of a color three-dimensional image of the object due to a difference between light emission intensities of light emissive element 720 and light emissive portion 730. As a result, the portion of the color three-dimensional image may have a perceived longitudinal position along light guide 616 which may be determined by a light emission intensity ratio between light emissive element 720 and light emissive portion 730.

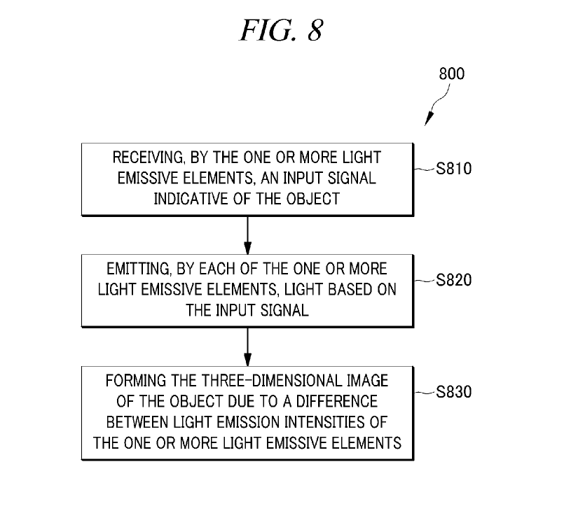

FIG. 8 illustrates an example flow diagram of a method adapted to display a three-dimensional image of an object in accordance with at least some embodiments described herein. An example method 800 in FIG. 8 may be implemented using, for example, a computing device including a processor adapted to display a three-dimensional image of an object in a display device. In some embodiments, the display device may include a plurality of light guides oriented substantially in a longitudinal direction and arranged in a two-dimensional array in a transverse plane, and one or more light emissive elements provided along the longitudinal direction of each of the light guides.

Method 800 may include one or more operations, actions, or functions as illustrated by one or more of blocks S810, S820, and/or S830. Although illustrated as discrete blocks, various blocks may be divided into additional blocks, combined into fewer blocks, or eliminated, depending on the desired implementation. In some further examples, the various described blocks may be implemented as a parallel process instead of a sequential process, or as a combination thereof. Method 800 may begin at block S810, “RECEIVING, BY THE ONE OR MORE LIGHT EMISSIVE ELEMENTS, AN INPUT SIGNAL INDICATIVE OF THE OBJECT.”

At block S810, an input signal indicative of the object may be received by the one or more light emissive elements. As depicted in FIG. 1, an input signal indicative of the object may be input to the light emissive elements provided along the longitudinal direction of each of light guides 116. This operation may be operated by controller 120 to control a light emission intensity of each of the light emissive elements based on the input signal. In some embodiments, the input signal may include three-dimensional coordinate information and/or color information of the object. Block S810 may be followed by block S820, “EMITTING, BY EACH OF THE ONE OR MORE LIGHT EMISSIVE ELEMENTS, LIGHT BASED ON THE INPUT SIGNAL.”

At block S820, light may be emitted, by each of the one or more light emissive elements, based on the input signal. As illustrated in FIG. 1, the light emissive elements of light guides 116 may emit light based on the input signal, which may include three-dimensional coordinate information and/or color information of the object. In some embodiments, the light emissive elements may include at least one of LEDs (e.g., red LEDs, green LEDs and blue LEDs), luminescent elements, and plasma light emissive element (or plasma light emitter) configured to generate light by exciting plasma of one or more noble gases. Block S820 may be followed by block S830, “FORMING THE THREE-DIMENSIONAL IMAGE OF THE OBJECT DUE TO A DIFFERENCE BETWEEN LIGHT EMISSION INTENSITIES OF THE ONE OR MORE LIGHT EMISSIVE ELEMENTS.”

At block S830, the three-dimensional image of the object may be formed due to a difference between light emission intensities of the one or more light emissive elements. As illustrated in FIG. 1, the light emissive elements may emit light with light emission intensities adjusted based on the three-dimensional coordinate information and/or color information of the object. Thus, the plurality of light guides 116 and the light emissive light elements may be collectively effective to form the three-dimensional image of the object due to a difference between light emission intensities of the light emissive elements. As a result, the three-dimensional image may have a perceived longitudinal position along each of light guides 116 which may be determined by at least one light emission intensity ratio between more than one light emissive elements of the plurality of light emissive elements 116.

One skilled in the art will appreciate that, for this and other methods disclosed herein, the functions performed in the methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

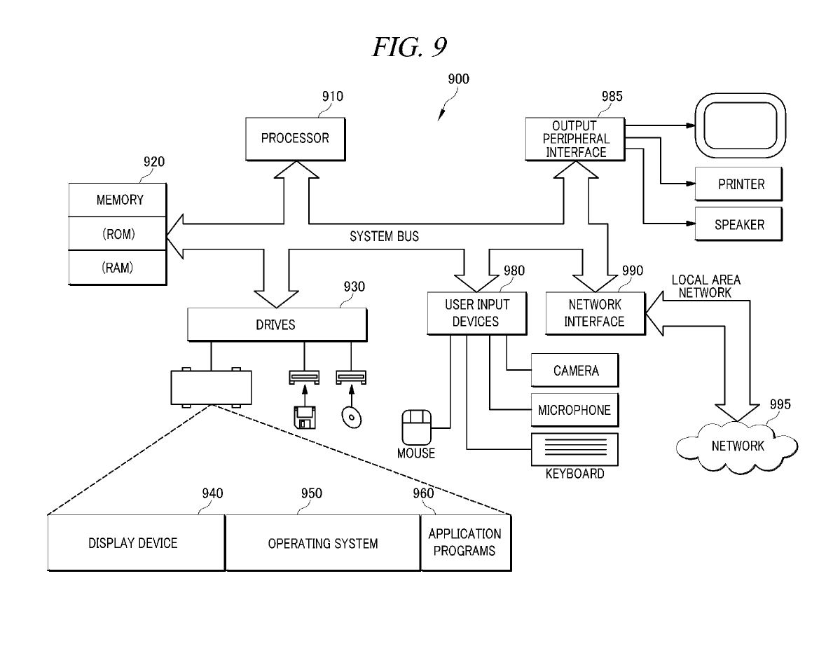

FIG. 9 shows a schematic block diagram illustrating an example computing system that can be configured to implement methods for displaying a three-dimensional image of an object, arranged in accordance with at least some embodiments described herein. As depicted in FIG. 9, a computer 900 may include a processor 910, a memory 920 and one or more drives 930. Computer 900 may be implemented as a conventional computer system, an embedded control computer, a laptop, or a server computer, a mobile device, a set-top box, a kiosk, a vehicular information system, a mobile telephone, a customized machine, or other hardware platform.

Drives 930 and their associated computer storage media may provide storage of computer readable instructions, data structures, program modules and other data for computer 900. Drives 930 may include a display device 940, an operating system (OS) 950, and application programs 960. Display device 940 may be adapted to display a three-dimensional image of an object in such a manner as described above with respect to FIGS. 1 to 8.

Computer 900 may further include user input devices 980 through which a user may enter commands and data. Input devices can include an electronic digitizer, a camera, a microphone, a keyboard and pointing device, commonly referred to as a mouse, trackball or touch pad. Other input devices may include a joystick, game pad, satellite dish, scanner, or the like.

These and other input devices can be coupled to processor 910 through a user input interface that is coupled to a system bus, but may be coupled by other interface and bus structures, such as a parallel port, game port or a universal serial bus (USB). Computers such as computer 900 may also include other peripheral output devices such as display devices, which may be coupled through an output peripheral interface 985 or the like.

Computer 900 may operate in a networked environment using logical connections to one or more computers, such as a remote computer coupled to a network interface 990. The remote computer may be a personal computer, a server, a router, a network PC, a peer device or other common network node, and can include many or all of the elements described above relative to computer 900.

Networking environments are commonplace in offices, enterprise-wide area networks (WAN), local area networks (LAN), intranets, and the Internet. When used in a LAN or WAN networking environment, computer 900 may be coupled to the LAN through network interface 990 or an adapter. When used in a WAN networking environment, computer 900 typically includes a modem or other means for establishing communications over the WAN, such as the Internet or a network 995. The WAN may include the Internet, the illustrated network 995, various other networks, or any combination thereof. It will be appreciated that other mechanisms of establishing a communications link, ring, mesh, bus, cloud, or network between the computers may be used.

In some embodiments, computer 900 may be coupled to a networking environment. Computer 900 may include one or more instances of a physical computer-readable storage medium or media associated with drives 930 or other storage devices. The system bus may enable processor 910 to read code and/or data to/from the computer-readable storage media. The media may represent an apparatus in the form of storage elements that are implemented using any suitable technology, including but not limited to semiconductors, magnetic materials, optical media, electrical storage, electrochemical storage, or any other such storage technology. The media may represent components associated with memory 920, whether characterized as RAM, ROM, flash, or other types of volatile or nonvolatile memory technology. The media may also represent secondary storage, whether implemented as storage drives 930 or otherwise. Hard drive implementations may be characterized as solid state, or may include rotating media storing magnetically encoded information.

Processor 910 may be constructed from any number of transistors or other circuit elements, which may individually or collectively assume any number of states. More specifically, processor 910 may operate as a state machine or finite-state machine. Such a machine may be transformed to a second machine, or specific machine by loading executable instructions. These computer-executable instructions may transform processor 910 by specifying how processor 910 transitions between states, thereby transforming the transistors or other circuit elements constituting processor 910 from a first machine to a second machine. The states of either machine may also be transformed by receiving input from user input devices 980, network interface 990, other peripherals, other interfaces, or one or more users or other actors. Either machine may also transform states, or various physical characteristics of various output devices such as printers, speakers, video displays, or otherwise.

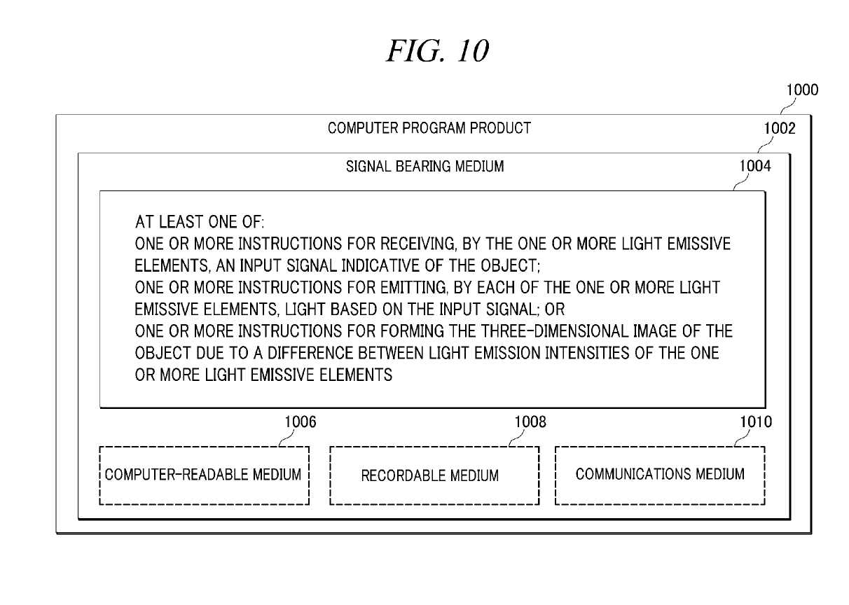

FIG. 10 illustrates computer program products that can be utilized to display a three-dimensional image of an object, arranged in accordance with at least some embodiments described herein. Program product 1000 may include a signal bearing medium 1002. Signal bearing medium 1002 may include one or more instructions 1004 that, when executed by, for example, a processor or a display device, may provide the functionality described above with respect to FIGS. 1 to 8. In some embodiments, the display device may include a plurality of light guides oriented substantially in a longitudinal direction and arranged in a two-dimensional array in a transverse plane, and one or more light emissive elements provided along the longitudinal direction of each of the light guides. By way of example, instructions 1004 may include at least one of: one or more instructions for receiving, by the one or more light emissive elements, an input signal indicative of the object; one or more instructions for emitting, by each of the one or more light emissive elements, light based on the input signal; or one or more instructions for forming the three-dimensional image of the object due to a difference between light emission intensities of the one or more light emissive elements. Thus, for example, referring to FIGS. 1 to 7B, display device 100 or 600 may undertake one or more of the blocks shown in FIG. 8 in response to instructions 1004.

In some implementations, signal bearing medium 1002 may encompass a computer-readable medium 1006, such as, but not limited to, a hard disk drive, a Compact Disc (CD), a Digital Video Disk (DVD), a digital tape, memory, etc. In some implementations, signal bearing medium 1002 may encompass a recordable medium 1008, such as, but not limited to, memory, read/write (R/W) CDs, R/W DVDs, etc. In some implementations, signal bearing medium 1002 may encompass a communications medium 1010, such as, but not limited to, a digital and/or an analog communication medium (e.g., a fiber optic cable, a waveguide, a wired communications link, a wireless communication link, etc.). Thus, for example, program product 1000 may be conveyed to one or more modules of display device 100 or 600 by an RF signal bearing medium 1002, where the signal bearing medium 1002 is conveyed by the communications medium 1010 (in this case a wireless communications medium, e.g., a wireless communications medium conforming with the IEEE 802.11 standard).

In some embodiments, a display device comprises an arrangement of light guides, such as a two-dimensional array of light guides. Light guides may be arranged generally parallel to each other along a direction of elongation, and may be generally perpendicular to a viewable surface of a display. One or more light emissive elements may be associated with each of at least some of the light guides. For example, a light guide may be elongated along a direction of elongation, and one or more light emissive elements may be located at different locations along the direction of elongation (which in some embodiments may be referred to as the longitudinal direction). In some embodiments, light emissive elements may be located in, adjacent to, or proximate to first and second end portions of the light guide. In some embodiments, a light emissive element may emit an electrically tunable spectrum, for example a multi-color LED. In some embodiments, light emissive elements of various colors may be arranged around each end portion of a light guide, and/or elsewhere along the light guide. Light from light emissive elements may be directed into a light guide, and then directed along the light guide, for example by an angled mirror or prism. In some embodiments, light from light emissive elements can illuminate the front side of the display device, and in some embodiments may also illuminate the back side of the display device. For some applications, it is advantageous to for light to emerge from both front and back sides of the display device, to provide two viewable display surfaces. In some embodiments, the illuminated side of the display may be selected, for example by a viewer, as one of two possible viewable sides. In some embodiments, an optical system and/or a display signal processing system may be included to obtain a mirror inversion of one side of the display, to enhance viewability. Applications of dual viewable surface displays may include displays having the appearance of a window, which may for example be placed between internal offices, for example to display a natural scene (such as a landscape scene).

Each of the light emissive elements may be configured to emit light based on an input signal indicative of the object. The input signal may include three-dimensional coordinate information for the object, and the light emissive elements may emit light based on the three-dimensional coordinate information of the object. In some embodiments, the light guide may be selected based on two-axis x and y coordinate information, and the ratio of emission intensities.

In some embodiments, a three-dimensional image of an object may be displayed based on differences between light emission intensities from the light emissive elements. In some embodiments, light emission intensity ratios between light emissive elements associated with the same light guide may be used to control an apparent (e.g. as perceived by a viewer) location of light emission along the light guide, and the apparent depth of a portion of the three-dimensional image. Electronic adjustment of intensity ratios between light emissive elements associated with the same (or in some examples, adjacent or proximate) light guide may be used to adjust an apparent location.

In some embodiments, a display may have both 2D and 3D operational modes. For example, in example 2D operational modes, only light emissive elements in approximately a single plane may be illuminated, such as light emissive elements near the front of the display (as perceived by a viewer). In example 3D operational modes, all light emissive elements may be selectable with adjustable intensity ratios as a function of longitudinal position to provide a perception of depth. In some embodiments, a 2D operational mode may allow illumination of all light emissive elements, with intensity ratios as a function of longitudinal position set at predetermined level so that the perceived plane of the display may be located between the ends of the light guides. In some embodiments, one or more of the light emissive elements may include one or more of the following: a plasma light emission element (for example, having visible or UV emission), electroluminescent elements (such a light emitting diode, laser, or other electroluminescent element, luminescent element (for example, converting UV emission to visible emission at one or more visible wavelengths), and the like.

In some embodiments, a light guide may comprise an optical fiber, elongated void in a matrix material, glass tube (such as a hollow glass tube), or other light guide structure. In some embodiments, a light guide may have first and second light emissive elements located at (or proximate) first and second ends of a light guide, respectively, with an apparent perceived light emission position located between the first and second ends as a function of a light intensity ratio between the first and second light emissive elements. In some embodiments, a viewer may be located such that a plurality of light emissive elements associated with each light guide may be perceived as a single light emissive element, with a perceived distance from the viewer that may be adjusted by adjusting the light intensity from each light emissive elements. For example, for a pair of light emissive elements perceived as a single light emissive element, the perceived location of the light emission may be located between the physical locations of the light emissive elements, and may be perceived as closer to the brighter light emissive elements, or mid-way between them in the example of an intensity ratio between them being unity.

In some embodiments, applications include a television, computer, mobile device (such as a mobile telephone), advertising display, signpost, artificial window, wall display, floor display, ceiling display, or other apparatus (such as an electronic device) including a 3D display as described herein. An electronic device may include a control circuit for converting a signal representing a 3D image into an appropriate control signal for the display, for example including calculating the intensity of light emissive elements. For example, the display intensity at the viewable surface of the display may be provided by a sum of light emissions from light emissive elements associated with the light guide, and the apparent position may be determined by one or more intensity ratios. Correction may be made for losses along the light guide. A calibration mode may be also be provided to compensate for losses, variations in light emissive element intensity, aging effects, and the like.

A display may have a viewable surface, sometimes termed the front of the display. the light guides having a light emissive end proximate to the viewable surface. In some embodiments, the light guides may extend longitudinally and generally perpendicular to the front viewable surface of the display. In some embodiments, the viewable surface may be curved (e.g. concave or convex), and the light guides may be non-parallel.

In some embodiments, the brightness of a display may be improved relative to, for example, a stack of liquid crystal displays, as there is no requirement for polarizers their associated light attenuation, and/or color filters which also introduce significant losses. In some embodiments, a display response time may be appreciably faster than a typical response time for a liquid crystal display. In some embodiments, a display have improved brightness and/or energy efficiency compared with, for example, a stack of liquid crystal panels, as light loss (e.g. for light from a backlight propagating through a plurality of optically absorbing panels) is reduced.

In some embodiments, a light guide may have a front end (from which viewable light is emitted) and a back end. In some embodiments, light reaching the back end may be absorbed and/or reflected back along the waveguide. In some embodiments, light emitted from the front end of a light guide, for example at the viewable surface, may have an adjusted (or adjustable) angular spread, for example using a refractive element (such as a lens, for example a diverging or converging lens), diffractive, or reflective element. A refractive element, such as a lens, in (or proximate the end of) the light guide may be effective to improve the viewing angle.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A display device configured to display a three-dimensional image of an object, the display device comprising:
a plurality of light guides oriented substantially in a longitudinal direction and arranged in a two-dimensional array in a transverse plane; and
one or more light emissive elements provided along the longitudinal direction of each of the plurality of light guides, each of the light emissive elements configured to emit light based on an input signal indicative of the object, wherein the light is guided in the longitudinal direction,
wherein the plurality of light guides and the one or more light emissive elements are effective to form the three-dimensional image of the object due to a difference between light emission intensities of the one or more light emissive elements.

2. The display device of claim 1, wherein the input signal includes three-dimensional coordinate information of the object, and wherein the one or more light emissive elements are configured to emit light based on the three-dimensional coordinate information of the object.

3. The display device of claim 1, wherein the plurality of light guides are formed of a plurality of optical fibers or of a plurality of hollow glass tubes.

4. (canceled)

5. The display device of claim 1, wherein the one or more light emissive elements comprise one or more LEDs (light emitting diodes).

6. The display device of claim 5, wherein each of the one or more light emissive elements comprises at least one of a red LED, a green LED and a blue LED.

7. The display device of claim 1, further comprising a LCD (liquid crystal display) panel arranged in a transverse plane of back ends of the plurality of light guides.

8. The display device of claim 1, wherein each of the one or more light emissive elements comprises a plasma light emissive element configured to generate light by exciting a plasma comprising one or more noble gases.

9. (canceled)

10. The display device of claim 8, wherein an inside of each of the plasma light emissive elements is coated with a fluorescent material, the fluorescent material including at least one of a red fluorescent material, a green fluorescent material, and a blue fluorescent material.

11. The display device of claim 10, wherein the fluorescent material comprises one or more materials selected from the group consisting of Y₂O₃:Eu, YP_{0.65}V_{0.35}O₄:Eu, YBO₃:Eu, Y_{0.65}Gd_{0.35}BO₃:Eu, Zn₂SiO₄:Mn, BaAl₁₂O₁₉:Mn, CaWO₄:Pb, Y₂SiO₅:Ce, YP_{0.85}V_{0.15}O₄, BaMg₂Al₁₄O₂₄:Eu, and BaMgAl₁₄O₂₃:Eu.

12. The display device of claim 1, wherein a plurality of light emissive elements is provided along the longitudinal direction of each of the plurality of light guides, wherein the plurality of light emissive elements includes the one or more light emissive elements.

13. The display device of claim 12, wherein the three dimensional image has a perceived longitudinal position along each of the plurality of light guides determined by at least one light emission intensity ratio between light emissive elements of the plurality of light emissive elements.

14. The display device of claim 1, wherein the one or more light emissive elements include a first light emissive element and a second light emissive element, and the three dimensional image has a perceived longitudinal position along each light guide of the plurality of light guides is based on a light emission intensity ratio between the first light emissive element and the second light emissive element.

15. The display device of claim 14, wherein the first light emissive element and the second light emissive element are separated by a longitudinal distance of at least half the length of the light guide.

16. A method for displaying a three-dimensional image of an object in a display device comprising:
a plurality of light guides oriented substantially in a longitudinal direction and arranged in a two-dimensional array in a transverse plane; and
one or more light emissive elements provided along the longitudinal direction of each of the light guides, wherein light emitted by the one or more light emissive elements is guided in the longitudinal direction,
wherein the method comprises:
receiving, by the one or more light emissive elements, an input signal indicative of the object;
emitting, by each of the one or more light emissive elements, light based on the input signal; and
forming the three-dimensional image of the object due to a difference between light emission intensities of the one or more light emissive elements.

17. The method of claim 16, wherein receiving, by the one or more light emissive elements, the input signal comprises receiving, by the one or more light emissive elements, the input signal including includes three-dimensional coordinate information of the object.

18. The method of claim 16, wherein emitting, by each of the one or more light emissive elements, light comprises emitting, by each of the one or more light emissive elements, light based on the three-dimensional coordinate information of the object.

19. The method of claim 16, wherein emitting, by each of the one or more light emissive elements, light comprises emitting, by one or more LEDs, light based on the input signal.

20. The method of claim 16, wherein emitting, by each of the one or more light emissive elements, light comprises generating, by a plasma light emissive element, light by exciting plasma of one or more noble gases based on the input signal.

21. The method of claim 16, wherein forming the three-dimensional image of the object includes controlling light emission intensity ratios between light emissive elements having differing longitudinal positions.

22. The method of claim 16, the display device having a plurality of light emissive elements disposed along the longitudinal direction of each of the plurality of light guides,
the method further comprising controlling a relative intensity of each of the plurality of light emissive elements to control a perceived longitudinal position of the three-dimensional image along each of the plurality of light guides.

23. The method of claim 16, further comprising:
emitting a first light emission from a first light emissive element having a first longitudinal position on a selected light guide,
emitting a second light emission from a second light emissive element having a second longitudinal position on the selected light guide,
whereby a portion of the three dimensional image has a perceived longitudinal position along the selected light guide that is located between the first longitudinal position and the second longitudinal position.

24. The method of claim 23, further comprising adjusting an intensity ratio between the first light emission and the second light emission to adjust the perceived longitudinal position of the portion of the three dimensional image.

25. (canceled)

26. (canceled)

27. (canceled)

28. (canceled)

29. (canceled)

30. A display device configured to display a three-dimensional image of an object, the display device comprising:
light guides arranged in an array, wherein each light guide is elongated along a longitudinal direction;
light emissive elements, wherein light emitted by the one or more light emissive elements is guided in the longitudinal direction; and
a controller operable to control a light emission intensity of each of the light emissive elements based on an input signal indicative of the object,
wherein the three-dimensional image has a perceived depth in the longitudinal direction determined by light emission intensity ratios between the light emissive elements.

31. The display device of claim 30, wherein each light guide is associated with a first light emissive element and a second light emissive element, the first light emissive element and the second light emissive element having different longitudinal positions along the longitudinal direction.

32. The display device of claim 31, wherein the three-dimensional image is formed by controlling a light emission intensity ratio between the first light emissive element and the second light emissive element for each light guide.

33. The display device of claim 31, wherein each light guide has a first end and a second end, and the first light emissive element is proximate the first end, and the second light emissive element is proximate the second end.

34. The display device of claim 31, wherein the three-dimensional image has a perceived depth along the longitudinal direction of each light guide determined by a light emission intensity ratio between the first light emissive element and the second light emissive element.

35. (canceled)

36. The display device of claim 30, wherein the light guides are selected from at least one of a group of light guides consisting of transparent-walled channels and elongated voids in a matrix material or a group of light guides consisting of optical fibers, glass rods, and glass tubes.

37. The display device of claim 30, wherein the light emissive elements include at least one of LEDs, plasma light emitters, or luminescent elements.

38. (canceled)

39. (canceled)

40. The display device of claim 39, wherein the luminescent elements are selected from a group of luminescent elements including fluorescent elements, photoluminescent elements, electroluminescent elements, cathodoluminescent elements, and phosphor elements.

41. The display device of claim 30, wherein a portion of the light emissive elements include light emissive pixels of a flat panel display.

42. The display device of claim 41, wherein the light guides extend from each light emissive pixel of a flat panel display to one of a second portion of the light emissive elements.
